(19) United States
(12) Patent Application Publication
(10) Pub. No.: US 2008/0024925 A1
(43) Pub. Date: Jan. 31, 2008

(54) Magnetic disk device

(75) Inventor: Kazunori Shikano, Higashine (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/727,707

(22) Filed: Mar. 28, 2007

(30) Foreign Application Priority Data
Jul. 28, 2006 (JP) 2006-205779
Jan. 24, 2007 (JP) 2007-014326

(51) Int. Cl. G11B 21/02

(52) U.S. Cl. 360/244

(57) ABSTRACT

The present invention provides a magnetic disk device which uses a plurality of screws of different weights for fastening a disk clamp, and which combines the screws of different weights in such a manner to eliminate weight imbalance. Accordingly, the device does not use extra components such as a weight for eliminating the weight imbalance, and thus achieves cost reduction.

### BACKGROUND OF THE INVENTION

1. Field of the Invention

The present invention relates to a magnetic disk device used as an external storage device of a computer system.

2. Description of the Related Art

A magnetic disk device is not only used as an auxiliary storage device of a computer but also mounted on a mobile terminal device, a video device, and so forth. With such expansion of the range of applications, further increase in capacity and improvement in response of the magnetic disk device have been sought. To increase the capacity, the number of disks mounted on the magnetic disk device has been increasing. Further, to improve the response, the rotation speed of a spindle motor has been increasing.

A plurality of the magnetic disks are stacked through a hub fixed to the shaft of the spindle motor, and a disk clamp is screwed to fix the disks. However, a slight gap exists between the hub of the spindle motor and the magnetic disks. Further, each of the magnetic disks, a disk spacer, and the disk clamp has eccentricity. After the magnetic disks have been fixed, therefore, weight imbalance occurs around the axis of the spindle motor.

Conventional art documents relating to the elimination of the weight imbalance include Japanese Unexamined Patent Application Publication Nos. 59-210565, 03-230309, and 2001-167554.

As a conceivable method to eliminate the weight imbalance around the axis of the spindle motor, for example, a balance adjusting weight may be separately prepared and placed at such a position that the weight eliminates the weight imbalance. According to the method, however, an extra component needs to be added, and thus the cost is increased. Further, a process of placing the weight needs to be added.

### SUMMARY OF THE INVENTION

One aspect is a magnetic disk device. The magnetic disk device includes at least one magnetic disk for recording information, a motor for rotating the magnetic disk, a disk clamp for fixing the magnetic disk to the motor, and a plurality of fastening members for fixing the disk clamp to the motor, at least one of said fastening members having a different weights from the others to generate an improved weight balance around the rotational axis of the motor.

According to the present invention, the weight imbalance is eliminated by fastening a disk clamp with screws having such weights that generate torque in the opposite direction to the direction in which the weight imbalance occurs. Therefore, the present invention has the effect of enabling the elimination of the weight imbalance without adding a new type of component.

### BRIEF DESCRIPTION OF THE DRAWINGS

FIG. 1 is an overview diagram of a magnetic disk device according to an embodiment of the present invention;

FIG. 2 is the first cross-sectional view of a spindle motor;

FIG. 3 is the first diagram illustrating weight imbalance;

FIG. 4 is the second diagram illustrating the weight imbalance;

FIG. 5 is the third diagram illustrating the weight imbalance;

FIG. 6 is the second cross-sectional view of the spindle motor;

FIG. 7 is the fourth diagram illustrating the weight imbalance;

FIG. 8 is the first diagram illustrating an example of a disk clamp;

FIG. 9 is the first cross-sectional view of the disk clamp;

FIG. 10 is the second diagram illustrating an example of the disk clamp;

FIG. 11 is the second cross-sectional view of the disk clamp; and

FIG. 12 is a cross-section diagram illustrating the spindle motor rotating.

### DESCRIPTION OF THE PREFERRED EMBODIMENTS

An embodiment of the present invention will be described below with reference to the drawings.

Structure of a Hard Disk Drive:

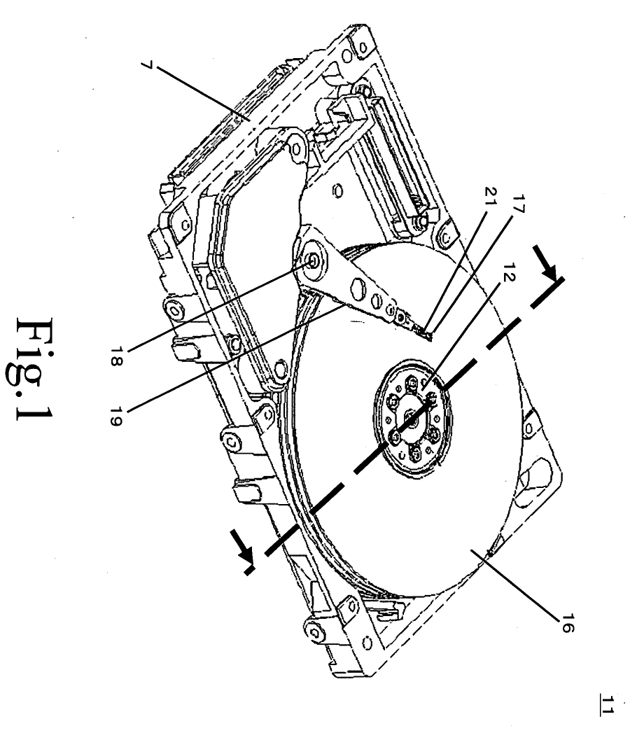

FIG. 1 schematically illustrates the internal structure of a specific example of a sealed recording disk drive, i.e., a hard disk drive (HDD) 11. The HDD 11 includes a box-shaped chassis body 7 for defining the internal space of a flat rectangular parallelepiped, for example. The housing space houses at least one magnetic disk 16 which serves as a recording medium. The magnetic disk 16 is mounted on a spindle motor 12. The spindle motor 12 can be rotated at a high speed, such as 7200 rpm, 10000 rpm, or 15000 rpm, for example.

The housing space further houses an actuator arm 19. The actuator arm 19 is provided for each of the front surface and the rear surface of the magnetic disk 16. The actuator arm 19 is attached with a head suspension 21 at the leading end thereof. The head suspension 21 extends forward from the leading end of the actuator arm 19. The front end of the head suspension 21 supports a floating head slider 17. The floating head slider 17 is set to face the surface of the magnetic disk 16.

The floating head slider 17 is mounted with a so-called magnetic head. The magnetic head may be formed by, for example, a reading section, such as a tunnel effect-type magnetoresistance effect element, which reads magnetic information from the magnetic disk 16 by using the tunnel effect, and a writing section, such as a thin film magnetic head, which is formed by a thin film coil pattern to write information on the magnetic disk 16 by using a magnetic flux.

The floating head slider 17 is applied with pressing force by the head suspension 21 toward the surface of the magnetic disk 16. Further, the floating head slider 17 is applied with buoyancy by the action of an air flow generated by the rotation of the magnetic disk 16. Due to the balance between the buoyancy and the pressing force applied by the head suspension 21, the floating head slider 17 can continue to float during the rotation of the magnetic disk 16.

The actuator arm 19 is connected to a drive power source, such as a voice coil motor, for example. Due to the operation of the voice coil motor, the actuator arm 19 can rotate around a spindle 18. When the actuator arm 19 oscillates around the spindle 18 during the flotation of the floating head slider 17, the floating head slider 17 can traverse over the surface of the magnetic disk 16 in the radial direction.

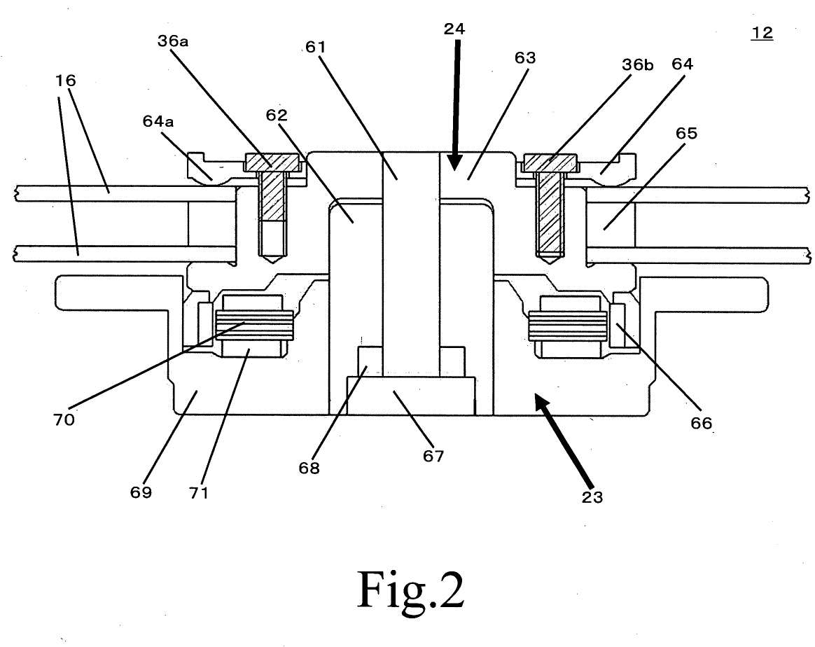

FIG. 2 is a cross-sectional view of the position indicated by the dashed line in FIG. 1, as viewed in the direction of the arrows. The figure illustrates the structure of the spindle motor 12. The spindle motor 12 is mainly formed by a stator 23 and a rotor 24 rotatably supported by the stator 23.

The stator 23 includes a sleeve 62. The sleeve 62 may be formed of a metal material, such as brass and stainless steel, for example. The sleeve 62 is formed with an opening at a lower portion thereof, and a thrust plate 67 is pressed into the opening. The stator 23 further includes a core 71 and a coil 70 wound around the core 71. The core 71 is formed by a plurality of stacked metal thin plates.

The rotor 24 includes a shaft 61. The shaft 61 includes a spindle hub 63 attached thereto. The shaft 61 is received by the sleeve 62. The space between the shaft 61 and the sleeve 62 is filled with oil. Thereby, the shaft 61 is supported by the sleeve 62. The shaft 61 is fixed with a disk-shaped thrust flange 68. The bottom surface of the thrust flange 68 is set to face a surface of the thrust plate 67. The shaft 61 and the thrust flange 68 may be formed of a metal material, such as brass and stainless steel, for example.

The shaft 61 is inserted in the spindle hub 63. The shaft 61 is adhered to the spindle hub 63 by an adhesive agent. The inner circumferential surface of the cylinder of the spindle hub 63 is fixed with a permanent magnet 66. Thereby, the permanent magnet 66 is set to face the coil 70. When the coil 70 is applied with a current, a magnetic flux generated by the coil 70 rotates the shaft 61 and the spindle hub 63. The spindle hub 63 is mounted with two magnetic disks 16, for example. Each of the magnetic disks 16 is pierced with a through hole at the center thereof to be mounted on the spindle hub 63. The through hole receives the spindle hub 63. Between the magnetic disks 16, a spacer 65 is inserted around the spindle hub 63 to be sandwiched by the magnetic disks 16. The spacer 65 keeps the interval between the magnetic disks 16. Further, the lower end of the spindle hub 63 is formed with a flange 69.

The leading end of the spindle hub 63 is attached with a disk clamp 64, which forms the first latch member. The disk clamp 64 is fixed to the spindle hub 63 by six screws 36 in a 3.5 inch type HDD, for example. The disk clamp 64 is formed with through holes for receiving the screws 36, each of which forms the second latch member. The disk clamp 64 has a projection 64a projecting from a surface thereof to come in contact with a surface of one of the magnetic disks 16. Thereby, the magnetic disks 16 and the spacer 65 are sandwiched between the disk clamp 64 and the spindle hub 63.

Detailed description will now be made of the mounting of the magnetic disks 16, the spacer 65, and the disk clamp 65 on the spindle motor 12. Firstly, the first magnetic disk 16 is mounted on the flange 69. In the mounting process, the spindle hub 63 moves into the through hole of the magnetic disk 16. After the first magnetic disk 16 has been mounted, the spacer 65 is mounted. Thereafter, the remaining magnetic disks 16 and spacers 65 are alternately mounted. After the last magnetic disk 16 has been mounted, the disk clamp 64 is mounted. In the mounting process, the through holes of the disk clamp 64 may be previously positioned to screw holes 57 formed in the spindle hub 63. Subsequently, the screws 36 are screwed through the through holes into the screw holes 57 with predetermined fastening torque.

The rotation of the magnetic disk 16 will be then described. When the coil 70 is applied with the current, drive force is generated between the coil 70 and the permanent magnet 66. Then, the shaft 61 starts rotating, and the oil flows along the inner circumferential surface of the sleeve 62. In this process, the oil generates dynamic pressure. Due to the dynamic pressure, a constant interval is secured between the outer circumferential surface of the shaft 61 and the inner circumferential surface of the sleeve 62. At the same time, a constant interval is secured between the bottom surface of the thrust flange 68 and the surface of the thrust plate 67. Accordingly, the magnetic disk 16 can continue to rotate. On the other hand, if the application of the current to the coil 70 is stopped, the rotational force of the shaft 61 is lost. Thereby, the rotation of the magnetic disk 16 stops.

Conceptual Diagram of Weight Imbalance:

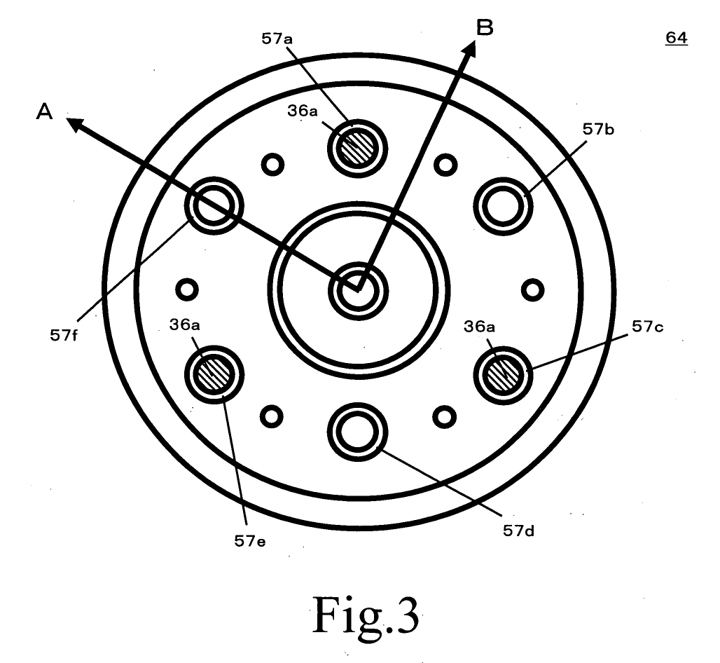

FIG. 3 is a diagram illustrating the magnetic disk device 11 of FIG. 1, as viewed from the above. The figure illustrates the disk clamp 64. Weight imbalance occurs around the axis of the spindle motor 12 in the directions indicated by the arrows in FIG. 3. The weight imbalance is caused by the eccentricity of each of the rotor 24, the magnetic disk 16, the disk spacer 65, and the disk clamp 64. When faster rotation of the spindle motor 12 is required, the eccentricity cannot be ignored, even if the accuracy of the components is improved. As a result, the weight imbalance occurs. To illustrate the directions in which the weight imbalance occurs, the present example illustrates a case in which the weight imbalance occurs in a direction connecting the center of the spindle motor 12 and the center of one of the screw holes 57 (57f), i.e., in the direction of A, and a case in which the weight imbalance occurs in a direction other than the above-described direction, i.e., in the direction of B.

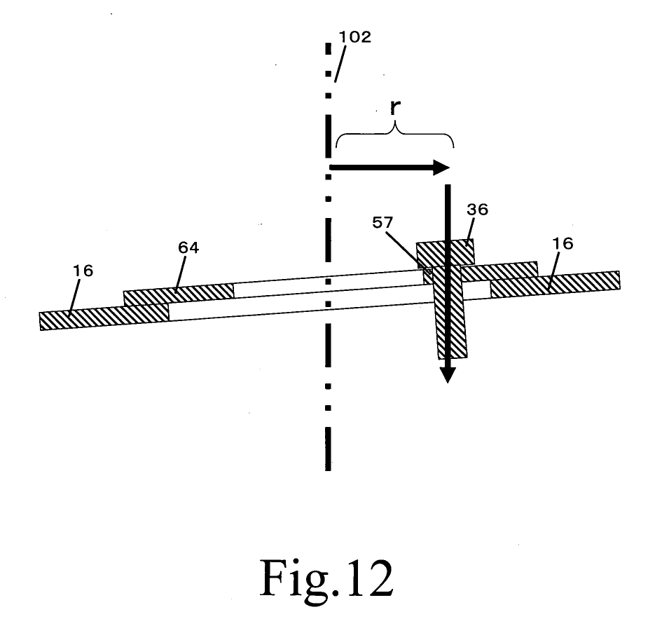

In the present embodiment, the weight imbalance is eliminated by using screws which are formed of the same material but have different lengths. That is, since the distance from the center of the rotational axis of the spindle motor 12 to the center of each of the screw holes 57 is constant, the weight of the screws 36 inserted in the screw holes 57 is changed to generate torque in the opposite direction to the direction in which the weight imbalance occurs, so that the weight imbalance is eliminated. FIG. 12 is a cross-section diagram of the spindle motor 12 rotating. For simplification, the figure illustrates the occurrence of the weight imbalance by using disk clamp 64 and disk 16. The weight imbalance of the disk 16 as illustrated in FIG. 12, is occurred when the spindle motor 12 is rotating. The weight imbalance is corrected by the weight of screw 36. The screw hole 57 is arranged to a predetermined position from a center axis of the disk 16 and a distance from the center axis 102 to the screw hole 57 is r. The screw has a weight to correct the weight imbalance at the screw hole 57 when the screw fastens at the screw hole 57. As the material of the screws 36, iron or stainless steel is used, for example. The different lengths of the screws 36 include three lengths of 3 mm, 6 mm, and 9 mm, for example. Since the material of the screws 36 is the same, the weight of the screws 36 is substantially proportional to the length thereof. Thus, the different weights of the screws 36 are 140 mg, 200 mg, and 280 mg, for example.

In fixing the disk clamp 64, the disk clamp 64 is first screwed by three screws 36a having a standard length of 6 mm into positions apart from one another by 120°, i.e., into the screw holes 57a, 57c, and 57e illustrated in FIG. 3. In this process, the torque generated in the screws 36a is such toque that temporarily holds the disk clamp 64 without causing a positional misalignment even if the magnetic disk 16 is rotated. This is because, if the disk clamp 64 is firmly fastened by the three screws 36a of the standard length, the effect of reducing the curve of magnetic recording medium is lost, as compared with the case in which the disk clamp 64 is firmly fastened by six screws 36 at the same timing. This is true even if the disk clamp 64 is screwed by the total of six screws 36 including three later-added screws 36 which include a screw 36 of a different length. Subsequently, the amount of imbalance is measured by an imbalance measuring device to detect the direction in which the weight imbalance occurs. And, the amount of imbalance is measured when the spindle motor 12 is rotating. Then, the combination of the screws 36 to be inserted in the three remaining holes 57 is determined such that the weight imbalance is eliminated.

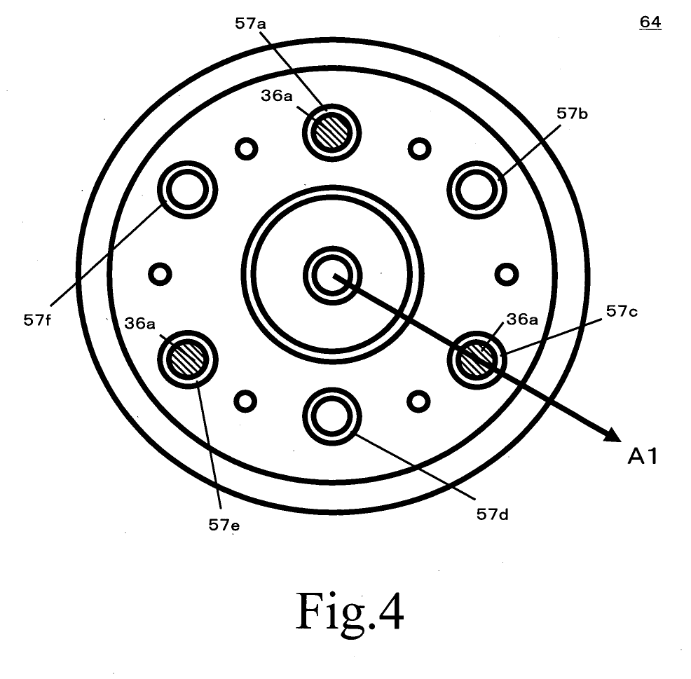

For example, if the weight imbalance occurs in the direction indicated by the arrow in FIG. 4 (i.e., in the direction of A1), a screw 36b having a longer length than the standard length is inserted in the screw hole 57f, and the screws 36a having the standard length are inserted in the screw holes 57b and 57d. Then, the screw 36b and the screws 36a inserted in the three remaining positions are fastened, and at the same time, the three previously temporarily fastened screws 36a are firmly fastened. Thereby, weight is applied in the opposite direction to the direction of A1, and thus the weight imbalance is eliminated. FIG. 2 illustrates the state in which the screw 36a having the standard length and the screw 36b having the longer length than the standard length are inserted.

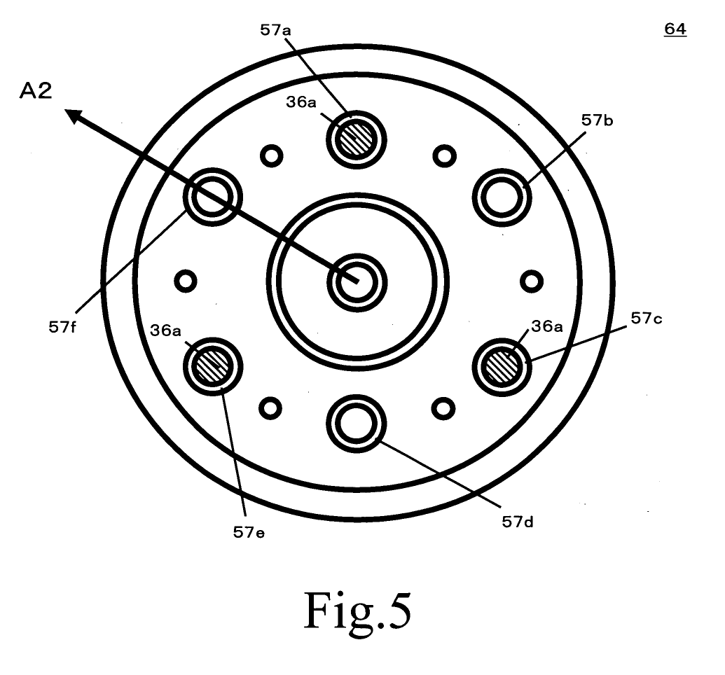

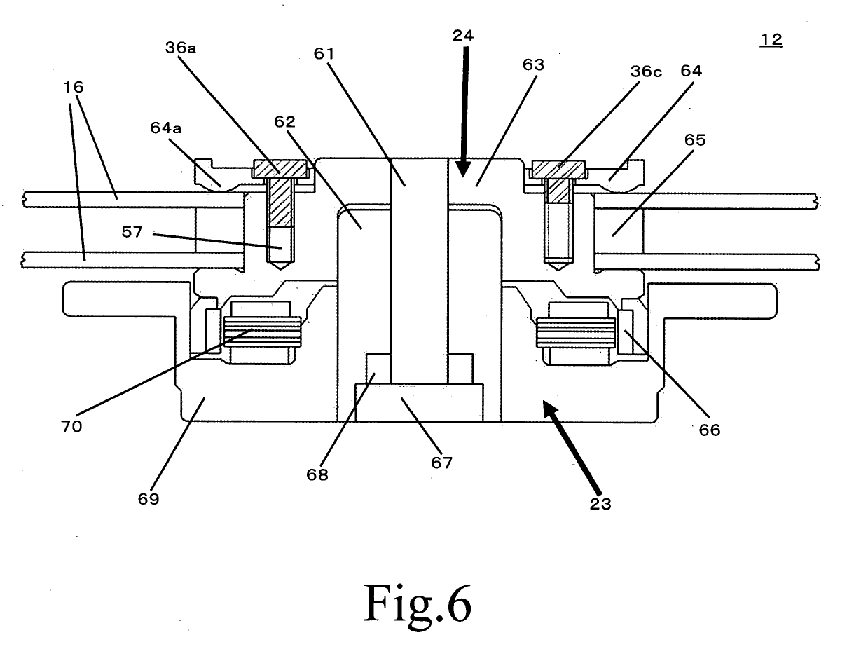

Further, if the weight imbalance occurs in the direction indicated by the arrow in FIG. 5 (i.e., in the direction of A2), a screw 36c having a shorter length than the standard length is inserted in the screw hole 57f, and the screw 36a having the standard length are inserted in the screw holes 57b and 57d. Then, the screw 36c and the screws 36a inserted in the three remaining positions are fastened, and at the same time, the three previously temporarily fastened screws 36a are firmly fastened. Thereby, weight is applied in the opposite direction to the direction of A2, and thus the weight imbalance is eliminated. FIG. 6 illustrates the state in which the screw 36a having the standard length and the screw 36c having the shorter length than the standard length are inserted.

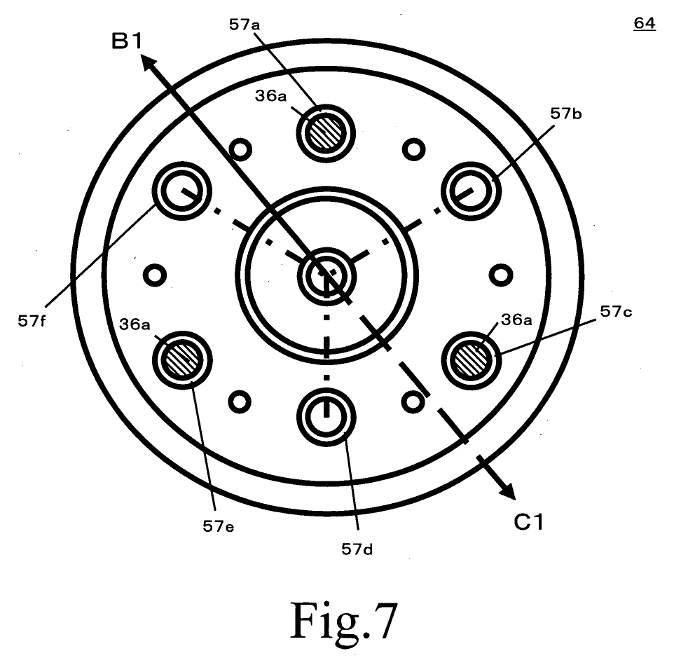

Furthermore, if the weight imbalance occurs in the direction indicated by the arrow in FIG. 7 (i.e., in the direction of B1), for example, the weight imbalance is eliminated by applying weight in the direction of C1, which is the opposite direction to the direction of B1. The weight is applied in the direction of C1 by combining the lengths of the screws 36 to be inserted in the screw holes 57b, 57d, and 57f. Specifically, the weight imbalance is eliminated by causing the torque, which corresponds to the product of the distance from the center of the spindle motor 12 to the center of each of the screw holes 57 and the weight of the screw 36 inserted in each of the screw holes 57, to be generated in the opposite direction to the direction in which the weight imbalance occurs. The centers of the respective screw holes 57 are positioned on the same circumference. Thus, as indicated by the dashed-dotted lines in FIG. 7, the distance from the center of the spindle motor 12 to the center of each of the screw holes 57 is constant. Therefore, the lengths of the screws 36 to be inserted in the screw holes 57b, 57d, and 57f are determined such that weight is applied in the direction of C1.

As described above, the combination of the screws depends on the direction in which the weight imbalance occurs. The combination of the screws varies depending on the measurement result. For example, screws having the same length as the length of the three previously fastened screws may be used. Further, two of the three screws to be used may be longer length than the previously fastened screws, and the remaining screw may be shorter than the previously fastened screws. Furthermore, two of the three screws to be used may be shorter than the previously fastened screws, and the remaining screw may be longer than the previously fastened screws. In addition, if further varied screw lengths are prepared instead of simply preparing the screws of the long length and the short length with respect to the standard screws, a finer control can be performed to reduce the imbalance.

Availability of the Present Invention:

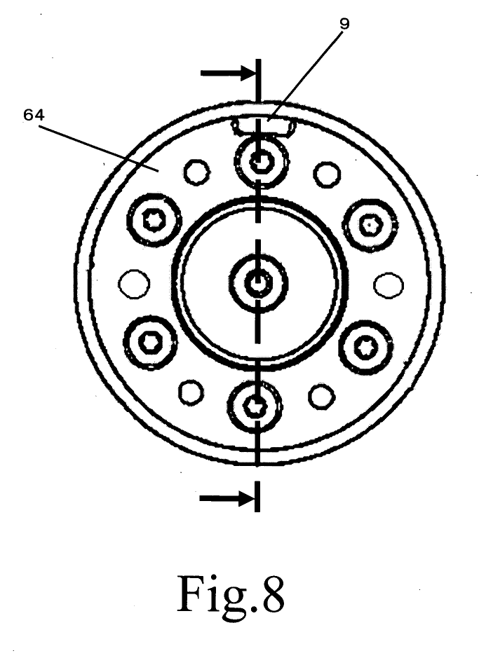

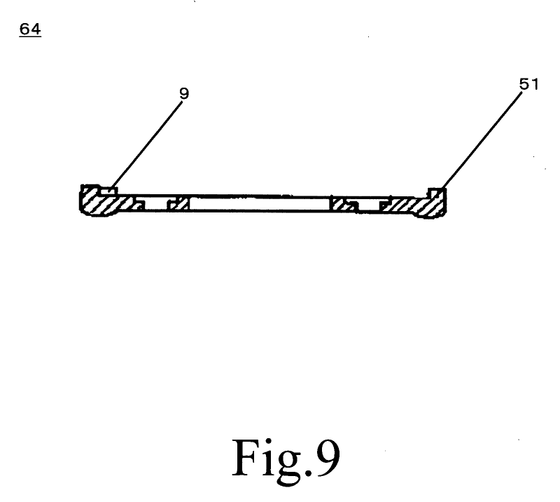

Finally, the availability of the present invention will be described. FIG. 8 illustrates an example of the disk clamp. FIG. 9 is a cross-sectional view of the portion indicated by the dashed line in FIG. 8, as viewed in the direction of the arrows. As illustrated in FIG. 9, the upper surface of the disk clamp is formed with a step 51. Further, an adjusting balancer weight 9, which functions as a balancer for keeping the rotational balance of the magnetic disk, is pasted to the step 51 by an adhesive agent along the inner wall of the step 51.

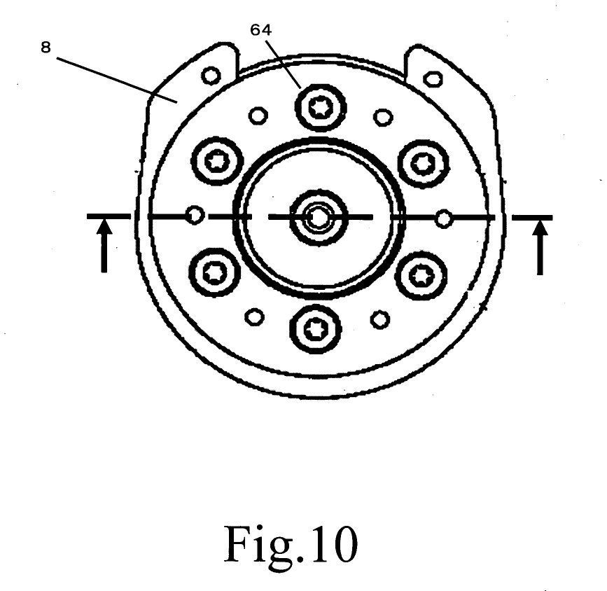

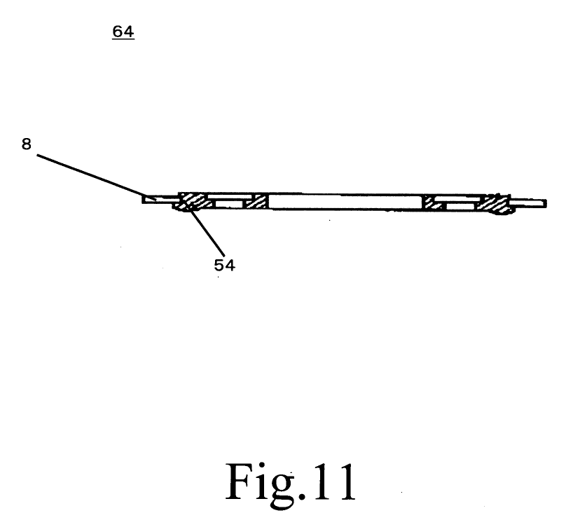

Further, FIG. 10 illustrates an example of the disk clamp. FIG. 11 is a cross-sectional view of the portion indicated by the dashed line in FIG. 10, as viewed in the direction of the arrows. As illustrated in FIG. 11, the balance in the circumferential direction of the disk clamp 64 is adjusted by a C-ring balancer 8 attached to the outer circumference of the disk clamp 64. More specifically, the lateral side of the outer circumference of the disk clamp 64 is formed with a groove 54 in which the C-ring balancer 8 is fitted.

On the other hand, according to the present invention, the weight imbalance is eliminated solely by the screws, without using extra components such as the weight and the C-ring balancer. Therefore, such processes as the pasting of the weight and the fitting of the C-ring balancer with respect to the disk clamp can be omitted.

The above-described embodiment has been specifically described for better understanding of the present invention, and thus does not limit other embodiments. Therefore, alternations can be made within a scope not changing the gist of the invention. For example, in FIG. 8, the screw having the long length may be inserted in the screw hole located nearest to the position to which the weight is pasted, and the screws having the standard length may be inserted in the other screw holes, to thereby exert a similar effect to the effect obtained by pasting the weight and to eliminate the weight imbalance. Further, the weight imbalance may be eliminated by using screws having the same size but formed of difference materials, i.e., screws having the same size but different weights, for example. Iron or stainless steel may be used as the material of a standard screw, while aluminum and brass may be used as the material of a screw lighter than the standard screw and the material of a screw heavier than the standard screw, respectively.

What is claimed is:

1. A magnetic disk device, comprising:
at least one magnetic disk for recording information;
a motor for rotating the magnetic disk;
a disk clamp for fixing the magnetic disk to the motor; and
a plurality of fastening members for fixing the disk clamp to the motor, at least one of said fastening members having a different weights from the others to generate an improved weight balance around the rotational axis of the motor.

2. The magnetic disk device of claim 1,
wherein said different weight fastening members generating a combined weight improving the weight imbalance.

3. The magnetic disk device of claim 1,
wherein said different weight fastening member generating a weight improving the weight imbalance.

4. A magnetic disk device, comprising:
at least one magnetic disk for recording information;
a motor for rotating the magnetic disk;
a disk clamp for fixing the magnetic disk to the motor;
a first group of fastening members for fixing the disk clamp to the motor; and
a second group of fastening members for generating an improved weight balance around the rotational axis of the motor with the disk clamp and the first group of fastening members.

5. The magnetic disk device of claim 4,
wherein said one group of fastening members generating a combined weight improving the weight imbalance.
